(19) United States
(12) Patent Application Publication
(10) Pub. No.: US 2018/0044538 A1
(43) Pub. Date: Feb. 15, 2018

(54) PROTECTIVE COATING COMPOSITION FOR MOLTEN ALUMINUM AND ALKALI METAL ENVIRONMENTS

(71) Applicant: Magneco/Metrel, Inc., Addison, IL (US)

(72) Inventors: Madjid Soofi, Elgin, IL (US); Lara BINZ, Volo, IL (US); Michael W. ANDERSON, West Chicago, IL (US)

(21) Appl. No.: 15/235,740

(22) Filed: Aug. 12, 2016

(51) Int. Cl. C09D 5/08; C09D 105/00

(52) U.S. Cl. CPC C09D 5/084; C09D 105/00

(57) ABSTRACT

The aqueous protective coating composition is provided for easy application to refractory linings and walls. When dried, the protective coating composition provides excellent chemical resistance to molten aluminum alkali metals and vapors. The protective coating composition includes alumina and silica, suitably provided as mullite, calcined alumina, and colloidal silica; and a metallic non-wetting agent.

### FIELD OF THE INVENTION

This invention is directed to a refractory composition that can be easily applied to molten metal containment vessels by brushing, rolling, spraying or the like. The composition protects the vessel walls against corrosion and other degradation caused by exposure to molten aluminum and alkali metals and vapors contained in the vessel.

### BACKGROUND OF THE INVENTION

Molten aluminum and molten alkali metals and vapors are known to attack refractory walls and linings made of alumina, silica, magnesia, magnesite, chromite, and other materials. Prolonged exposure to these molten metals and vapors promotes corrosion and degradation of various parts of furnaces and other containment vessels, including walls, ceilings, roofs, exhaust ducts, floors, ramps, skim shelves, spouts, tap holes, troughs, runners, launders, lentils, door jams, and doors. In the past, this required periodic replacement of the refractory linings and/or the containment vessels. This periodic replacement often entailed significant down time and expense.

Only a small amount of corrosion and degradation is required to adversely affect the thermal insulation properties of the refractory wall or lining. When the refractory wall or lining is formed of alumina-silicate, as is commonly the case, the molten aluminum chemically reacts with the refractory to form corundum, which is a mixture of Al₂0₃ with unreacted Si and Al. This reaction product strongly attaches itself to the refractory by filling its porosity, and is very difficult to remove.

By way of example, molten aluminum reacts with silica in the refractory wall or lining as follows:

4Al+3Si0₂→2Al₂0₃+3Si

If the molten aluminum is a metal-bearing alloy, such as an aluminum-magnesium alloy, the following additional reactions may occur:

2Mg+Si0₂→2Mg0+Si

3Mg+4Al₂0₃→3MgAl₂0₄+2Al

Other oxides frequently found in refractions are also reduced by reaction with molten aluminum and alkali metals and vapor. These include oxides of titanium and iron, for example. There is a need or desire for an easy-to-apply coating that protects refractory walls and linings from chemical attack by molten aluminum and alkali metals and vapors.

### SUMMARY OF THE INVENTION

The present invention is directed to an aqueous coating composition that can be easily applied to any ceramic or masonry surface by brushing, rolling, spraying or the like, and subsequently dried. The invention is also directed to the dried coating composition. The dried coating composition protects the ceramic or masonry surface from chemical attack from molten aluminum and/or alkali metals and vapors.

The dried protective coating composition includes the following ingredients:

about 20% to about 90% by weight Al₂0₃;

about 15% to about 55% by weight Si0₂; and

about 1% to about 40% by weight of a metallic non-welting agent;

wherein the Al₂0₃, Si0₂, and non-wetting agent together constitute

at least about 90% by weight of the protective coating

composition.

The aqueous coating composition includes about 5% to about 40% by weight water and about 60% to about 95% by weight solids. The solids include, on a dry weight basis:

about 20% to about 90% by weight Al₂0₃ (excluding calcined alumina);

about 15% to about 55% by weight Si0₂; and

about 1% to about 15% by weight of a metallic non-wetting agent;

wherein the Al₂0₃, Si0₂, and non-wetting agent together constitute

at least about 90% by weight of the solids.

Some of the Al₂0₃ and Si0₂ are suitably in the form of mullite, having the chemical formula 3Al₂0₃.2Si0₂. Some of the silica is suitably added with the water in the form of colloidal silica. Some of the alumina can be in the form of calcined alumina. The non-wetting agent is believed to combine with the Al₂0₃ and Si0₂ to form a combination which resists penetration and reaction with molten aluminum and alkali metals and vapors, thereby providing the protective coating.

With the foregoing in mind, it is a feature and advantage of the invention to provide a protective coating composition for molten aluminum and alkali metal environments that can be easily applied and re-applied to a ceramic or masonry surface by brushing, spraying, rolling or similar techniques.

It is also a feature and advantage of the invention to provide an environmentally safe protective coating composition that is substantially free of organic components.

It is also a feature and advantage of the invention to provide a protective coating composition for molten aluminum and alkali metal environments, that is relatively inexpensive to formulate, purchase and use.

These and other features and advantages of the invention will become further apparent from the following detailed description of the invention.

### DETAILED DESCRIPTION OF THE INVENTION

The invention is directed to an aqueous protective coating composition that can be easily applied to a concrete or masonry surface by brushing, spraying, rolling or the like and subsequently dried. The invention is also directed to the dried protective coating composition that provides effective protection in molten aluminum and alkali metal environments.

The dried protective coating composition comprises about 20% to about 90% by weight Al₂0₃. Suitably, the dried protective coating composition includes about 30% to about 70% by weight Al₂0₃, or about 40% to about 60% by weight Al₂0₃. The dried protective coating composition comprises about 15% to about 55% by weight Si0₂. suitably about 25% to about 50% by weight Si0₂, or about 30% to about 45% by weight Si0₂.

Some or all of the Al₂0₃ and some of the Si0₂ can be provided as mullite having the chemical formula 3Al₂S0₃.2Si0₂. The mullite can be micronized to a median particle diameter of about 1-100 microns, suitably about 2-10 microns. One suitable commercially available mullite is MJ5M micronized Mullite, available from the Kyanite Mining Corporation in Dillwyn, Va. MJ5M Micronized Mullite has a median particle diameter of about 4-5 microns and contains about 55-60% by weight Al₂0₃, about 38-43% by weight Si0₂, less than about 1% by weight Fe₂0₃, about 1-2% by weight Ti0₂, and less than about 1% by weight alkali and alkaline earth metal oxides (e.g., CaO, MgO, Na₂0O, K₂0). The mullite may constitute about 30% to about 70% by weight of the dried protective coating composition, suitably about 40% to about 60% by weight. The use of micronized mullite improves the particle packing and the stability of the dried protective coating composition.

Some of the Al₂0₃ can be calcined alumina, suitably having a median particle size of about 1 to about 50 microns, or about 2 to about 25 microns, or about 3 to about 10 microns. When calcined alumina is present, the dried protective coating composition may include about 5% to about 40% by weight calcined alumina, or about 15% to about 35% by weight calcined alumina, or about 20% to about 30% by weight calcined alumina. One suitable calcined alumina is sold under the name AC2-325M, available from AluChem, Inc. of Reading, Ohio. Calcined alumina can be purchased or made by calcining aluminum powder at 1200-1300° C. to convert it to pure Al₂0₃.

Some of the Si0₂ can be colloidal silica having a median particle diameter of about 1-100 nanometers, suitably about 4-100 nanometers, or about 6-50 nanometers, or about 8-20 nanometers. The colloidal silica is provided in an aqueous colloidal suspension that includes about 30-60% by weight colloidal silica particles and about 40-70% by weight water, suitably about 40% by weight colloidal silica particles and about 60% by weight water. When the protective coating composition is dried, the colloidal silica particles act as a binder between the remaining ingredients and to the substrate. The colloidal silica particles may constitute about 5% to about 30% by weight of the dried protective coating composition, suitably about 10% to about 25% by weight.

The dried protective coating composition includes about 1% to about 1 5% by weight of a metallic non-wetting agent, suitably about 3% to about 13% by weight, or about 5% to about 12% by weight. The metallic non-wetting agent is non-wetting as to molten aluminum and alkali metals and vapors, and resists wetting by these metals. It is believed that the metallic non-wetting agent combines with the alumina and/or silica in the protective coating composition to provide the overall composition with non-wetting properties and substantial chemical inertness to molten aluminum (including aluminum-based alloys) and alkali metals and vapors.

A wide variety of metallic non-wetting agents can be employed in the protective coating composition. Examples of metallic non-wetting agents include metal phosphates such as lanthanum phosphate, trisodium phosphate, tetrasodium phosphate, sodium pyrophosphate, magnesium phosphate, potassium phosphate, barium phosphate, iron (III) phosphate, copper (III) phosphate, iron (II) phosphate, calcium phosphate, nickel (II) phosphate, strontium phosphate, aluminum phosphate, aluminum hydrogen phosphate, aluminum dihydrogen phosphate, aluminum pyrophosphate, aluminum perphosphate, aluminum metaphosphate, and combinations thereof. When heated to temperatures above 980° C. to temperatures characteristic of an aluminum melting furnace, these phosphates can combine with the alumina to form an aluminum orthophosphate bond, providing the protective coating composition with a high degree of resistance to molten metal attack.

Other examples of metallic non-wetting agents include zirconium silicates such as zirconium metasilicate (Zr (Si0₃)₂) and zirconium orthosilicate (ZrSi0₄); Group II metal sulfates such as barium sulfate, strontium sulfate, calcium sulfate and magnesium sulfate; and combinations thereof. These compounds may decompose at high temperatures to form oxides which in turn, react with alumina to form stable oxides phases. For example, barium sulfate decomposes into barium oxide (BaO) at high temperatures, which in turn combines with the alumina to form barium hexaluminate (BaO.6Al₂O₃) or the monaluminate spinel (BaO.Al₂O₃), both of which are stable and resistant to molten metal attack.

Other examples of metallic non-wetting agents include Group II metal halides such as barium fluoride, barium chloride, barium bromide, strontium fluoride, strontium chloride, strontium bromide, calcium fluoride, calcium chloride, calcium bromide, magnesium fluoride, magnesium chloride, magnesium bromide, and combinations thereof. These compounds are thermodynamically stable, with relatively high heats of formation, and exhibit non-wetting and de-wetting behavior at temperatures exceeding 1100° C.

Other examples of metallic non-wetting agents include metallic nitrides such as boron nitride, zirconium nitride, aluminum nitride, silicon nitride, and the like; metallic carbides such as barium carbide, aluminum carbide, tungsten carbide, tungsten-nickel carbide complexes, and the like; and combinations thereof. These compounds are thermodynamically stable at high temperatures, and are non-wetting and resistant to chemical reaction with molten aluminum and alkali-based metals.

Other examples of metallic non-wetting agents include compounds and complexes of aluminum and/or silicon that combine with the Al₂O₃ and/or SiO₂ to provide reduced wetting and increased resistance to attack by molten aluminum and alkali metals and vapors. Examples include without limitation magnesium aluminate spinel (MgAl₂O₄); stack structures of alumina and zirconia such as ZrO₂.Al₂O₃, ZrO₂.Al2O₃.ZrO₂, and Al₂O₃.ZrO2.Al₂O₃; aluminum halides such as aluminum fluoride aluminum chloride, aluminum bromide, sodium aluminum tetrafluoride, sodium aluminum tetrachloride, sodium aluminum tetrabromide, potassium aluminum tetrafluoride, potassium aluminum tetrachloride, and potassium aluminum tetrabromide; calcium aluminate, calcium hexaluminate (CₐO.6Al₂O₃), aluminum titanate (Al₂TiO₅), calcium silicate, and combinations thereof.

Other examples of metallic non-wetting agents include Group II metal carbonates and celsians such as barium carbonate, strontium carbonate, barium celsian, strontium celsian, and combinations thereof. Also included are fluorides, chlorides and bromides of titanium, zirconium, hafnium, copper and strontium, and combinations thereof.

The Al₂O₃, SiO₂, and non-wetting agent together should constitute at least about 90% by weight, or at least about 94% by weight, or at least about 97% by weight of the dried protective coating composition. All other ingredients (including impurities, if any) should be kept to a minimum.

The dried protective coating composition may also include about 0.01% to about 2% by weight, suitably about 0.01% to about 1% by weight of a water-soluble thickening agent. Suitable thickening agents include without limitation water-soluble synthetic or natural gums which help maintain the solid ingredients in suspension before drying. Suitable gums include without limitation xanthan gum, guar gum, alginates, locust bean gum, and combinations thereof One suitable gum is xanthan gum sold under the name KELZAN® by CP Kelco Co. of Atlanta, Ga.

Except for the thickening agent, the dried protective coating composition is either free or substantially free of organic ingredients. When present, the sum of all organic ingredients, inclusive of the thickening agent, is suitably not more than about 8% by weight, or not more than 5% by weight, or not more than about 2.5% by weight of the dried protective coating composition. The relative absence of organic components promotes a healthy and safe work environment. The protective coating compositions should also be free or substantially free of gelling agents, acidic compounds, alkali hydroxides and other strong bases.

The present invention also includes the aqueous protective coating composition prior to drying. The aqueous protective coating composition comprises about 5% to about 40% by weight water, suitably about 10% to about 30% by weight water, or about 15% to about 25% by weight water. Most or all of the water is combined with colloidal silica in the amounts indicated above, to form an aqueous colloidal dispersion. The aqueous colloidal dispersion is then mixed with the remaining ingredients of the protective coating composition to form an aqueous protective coating composition including about 60% to about 95% by weight solids, suitably about 70% to about 90% by weight solids, or about 75% to about 85% by weight solids. Water can be the only liquid component. The aqueous protective coating composition should be free, or substantially free, of organic liquids. The term “substantially free” indicates an organic liquid content of not more than about 8% by weight, or not more than about 5% based on the total liquid weight.

The aqueous colloidal silica dispersion and the remaining solid ingredients are mixed together to form an aqueous protective coating composition which, excluding the water, contains the same solid ingredients in the same amounts as described above for the dried protective coating composition. The aqueous protective coating composition is then applied to a ceramic or masonry surface using brushing, spraying rolling, or another suitable technique. After application, the aqueous protective coating composition is dried with or without heat to provide the dried protective coating having the composition described above.

### Example 1

An aqueous protective coating composition was prepared by mixing the following materials together in the following amounts.

| No. | Ingredient | Weight Percent |
|---|---|---|
| 1 | Xanthan Gum (KELZAN ®) | 0.051 |
| 2 | Water | 1.698 |
| 3 | Aqueous Colloidal Silica, 40% Silica | 35.350 |
| 4 | Micronized Mullite, 58% Al₂O₃, | 37.740 |
| | 40% SiO₂ (MJ5M) | |
| 5 | Calcined Alumina, 6 microns (AC2 - 325M) | 16.983 |
| 6 | Metallic Non-wetting Agent | 8.177 |
| | TOTAL | 100.00 |

Broken down by ingredients, the aqueous protective coating composition contained the following:

| No. | Ingredient | Weight Percent |
|---|---|---|
| 1 | Xanthan Gum (KELZAN ®) | 0.051 |
| 2 | Water | 22.908 |
| 3 | Colloidal Silica | 14.140 |
| 4 | Silica from Mullite | 15.096 |
| 5 | Al₂O₃ from Mullite | 21.890 |
| 6 | Impurities from Mullite | 0.755 |
| 6 | Calcined Alumina | 16.983 |
| 7 | Metallic Non-wetting Agent | 8.177 |
| | TOTAL | 100.00 |

The aqueous protective coating composition can be prepared by first combining and mixing the synthetic or natural gum (ingredient 1) with water (ingredient 2) to provide a first mixture. The first mixture can be combined with the aqueous colloidal silica (40% silica) in a separate container using a stirring blade for about 5 minutes, or the time needed to achieve homogeneity, to provide a second mixture. The mullite, calcined alumina and non-wetting agent can then be slowly added to the second mixture and stirred for about 10 minutes, or a time needed to achieve homogeneity. The resulting aqueous protective coating composition can settle during prolonged storage, and can be stirred again prior to use.

The aqueous protective coating composition can then be applied to a concrete or masonry surface, such as a refractory wall or lining used to contain molten aluminum in a furnace or vessel. After drying, the resulting dried protective coating has the following composition.

| No. | Ingredient | Percent by Weight |
|---|---|---|
| 1 | Xanthan Gum | 0.067 |
| 2 | Colloidal Silica | 18.342 |
| 3 | Silica from Mullite | 19.582 |
| 4 | Al₂O₃ from Mullite | 28.421 |
| 5 | Impurities from Mullite | 0.980 |
| 5 | Calcined Alumina | 22.031 |
| 6 | Metallic Non-wetting Agent | 10.607 |
| | TOTAL | 100.00 |

### Example 2

An aqueous protective coating composition prepared according to Example 1 was coated on one side of a 65% alumina refractory cup that had been pre-filled to 1832° F. The other side of the cup was uncoated. The cup was then filled with a 7075 molten aluminum alloy mixed with 2.5% magnesium and was maintained at a temperature of 1562° F. for 120 hours. The cup was then emptied and observed. The coated side of the cup showed no visual evidence of reaction with the molten metal. The uncoated side of the cup showed substantial visual evidence of corrosion and degradation.

### Example 3

Using the low cement castable (LCC) refractory cups, one cup was fully coated with the aqueous refractory composition of Example 1 and the other cup was left uncoated. Both cups were filled with K₂CO₃, sealed, and heated to 1100° C. (2012° F.) for five hours in a sealed sagar. Then, the cups were emptied and inspected. The coated cup showed no visual evidence of reaction with the molten alkali metal. The uncoated cup showed substantial visual evidence of corrosion and degradation.

The embodiments of the invention described herein are exemplary. Various modifications and improvements can be made without changing the spirit and scope of the invention. The scope of the invention is indicated by the appended claims, and all changes that fall within the meaning and scope of equivalents are intended to be embraced therein.

We claim:

1. A protective coating composition for molten aluminum and alkali metal environments, comprising on a dry weight basis:
about 20% to about 90% by weight Al₂O₃;
about 15% to about 55% by weight SiO₂; and
about 1% to about 15% by weight of a metallic non-wetting agent;
wherein the Al₂O₃, SiO₂, and non-wetting agent together constitute at least about 90% by weight of the protective coating composition.

2. The protective coating composition of claim 1, wherein the Al₂O₃, SiO₂, and metallic non-wetting agent together constitute at least about 94% by weight of the protective coating composition.

3. The protective coating composition of claim 1, wherein the Al₂O₃, SiO₂, and metallic non-wetting agent together constitute at least about 97% by weight of the protective coating composition.

4. The protective coating composition of claim 1, wherein some of the Al₂O₃, and some of the SiO₂ are provided in the form of 3Al₂O₃.2SiO₂, the 3Al₂SO₃.2SiO₂ constituting about 30% to about 70% by weight of the protective coating composition.

5. The protective coating composition of claim 1, wherein some of the SiO₂ is provided in the form of colloidal silica particles having a mean particle diameter of about 1 to about 100 nanometers, the colloidal silica particles constituting about 5% to about 30% by weight of the protective coating composition.

6. The protective coating composition of claim 1, wherein some of the Al₂O₃ is provided in the form of calcined alumina having a mean particle diameter of about 1 to about 100 microns, the calcined alumina constituting about 5% to about 40% by weight of the protective coating composition.

7. The protective coating composition of claim 1, further comprising about 0.01% to about 2% by weight of a synthetic or natural gum.

8. The protective coating composition of claim 1, wherein the metallic non-wetting agent is selected from the group consisting of metal phosphates, zirconium silicates, Group II metal sulfates, Group II metal halides, metallic nitrides, and combinations thereof.

9. The protective coating composition of claim 1, wherein the metallic non-wetting agent is selected from the group consisting of magnesium aluminate spinel, stack structures of alumina and zirconia, alumina halides, calcium aluminate, calcium hexaluminate, calcium silicate, aluminum titanate, and combinations thereof.

10. The protective coating composition of claim 1, wherein the metallic non-wetting agent is selected from the group consisting of Group II metal oxides; Group II metal celsians; fluorides, chlorides and bromides of titanium, zirconium, halfnium, copper and strontium; and combinations thereof.

11. The protective coating composition of claim 1, wherein the metallic non-wetting agent is present at about 5 to about 12% by weight.

12. The protective coating composition of claim 1, further comprising about 0.01% to about 2% by weight of a synthetic or natural gum.

13. An aqueous protective coating composition, comprising about 5% to about 40% by weight water and about 60% to about 95% solids, wherein the solids include, on a dry weight basis.
about 20% to about 90% by weight Al₂0₃;
about 15% to about 55% by weight SiO₂; and
about 1% to about 15% by weight of a metallic non-wetting agent;
wherein the Al₂0₃, SiO₂, and metallic non-wetting agent constitute at least 90% by weight of the solids; and
the aqueous protective coating composition is substantially free of organic liquids.

14. The aqueous protective coating composition of claim 13, wherein some or all of the Al₂0₃ and some of the SiO₂ are in the form of mullite having the formula 3Al₂0₃.2Si0₂.

15. The aqueous protective coating composition of claim 14, wherein the mullite constitutes about 30% to about 70% by weight of the solids.

16. The protective coating composition of claim 13, wherein some of the Al₂O₃ is provided in the form of calcined alumina having a mean particle diameter of about 1 to about 100 microns, the calcined alumina constituting about 5% to about 40% by weight of the protective coating composition.

17. The aqueous protective coating composition of claim 15, wherein the SiO₂ further comprises colloidal silica in an amount of about 5% to about 35% by weight of the solids.

18. The aqueous protective coating composition of claim 17, wherein the solids further comprise about 0.01% to about 2% by weight of a synthetic or natural gum.

19. The protective coating composition of claim 18, wherein the Al₂O₃, SiO₂, and metallic non-wetting agent together constitute at least about 94% by weight of the protective coating composition.

20. The protective coating composition of claim 18, wherein the Al₂O₃, SiO₂, and metallic non-wetting agent together constitute at least about 97% by weight of the protective coating composition.

21. A protective coating composition for molten aluminum and alkali metal environments, comprising on a dry weight basis:
about 30% to about 70% by weight mullite;
about 5% to about 30% by weight colloidal silica particles;
about 15% to about 35% by weight calcined alumina; and
about 3% to about 13% by weight of a metallic non-wetting agent;
wherein the mullite, colloidal silica particles, calcined alumina; and metallic non-wetting agent together constitute at least about 94% by weight of the protective coating composition.
